(19) United States
(12) Patent Application Publication
(10) Pub. No.: US 2010/0128855 A1
(43) Pub. Date: May 27, 2010

(54) Method and apparatus for a messaging system to enable two or more individuals to communicate using a text messaging system and a conventional telephone

(76) Inventors: Mark D. Demo, Bloomfield, NJ (US); Abhinav Mahendra, Jersey City, NJ (US)

Correspondence Address: Mark D. Demo, 62 Bell Street, Bloomfield, NJ, 07003, US

(21) Appl. No.: 12/313,664

(22) Filed: Nov. 21, 2008

(51) Int. Cl. H04M 11/00

(52) U.S. Cl. 379/88.13

(57) ABSTRACT

Computer based email systems and VOIP based messaging systems have generally been regarded as distinct means of communication. In many instances, however, a potential sender of a message may have access to only email services while at the same time, the desired recipient of the message may only have access to a telephone. Thus, it would be advantageous if the sender could send an email which could be converted to a voice message and delivered directly to the recipient(s) telephone and the recipient could record a voice message which, in turn, could be converted to a text message and returned back to the original sender of the email.

The present invention relates to a method and apparatus for a messaging system to enable two or more individuals to communicate using a text messaging system and a conventional telephone. The messaging system generating a voice message based on an email sent to a web site and a text message based on a voice mail sent to a web site is disclosed. The messages are delivered via the Internet and directly transmitted to an individual, or group of individual's telephone numbers and email addresses.

### SUMMARY OF THE INVENTION

The present invention provides a technique for generating a voice message from an email sent to a web site hosted on a web server. The voice message is transmitted over the Internet directly to a telephone to an individual or group of individuals.

According to one illustrative embodiment, a web site receives an email which in turn generates a voice message to an individual or group of individuals based on the text in the body of the email. The voice message comprises speech signals corresponding to text in the body of the email.

According to another illustrative embodiment, a web site receives an email with a spreadsheet attachment which in turn generates a voice message to an individual or group of individuals based on the text in the spreadsheet attachment. The voice message created comprises speech signals corresponding to text in the spreadsheet attached to the email.

In accordance with yet another illustrative embodiment, a spreadsheet is uploaded directly to a web site which in turn generates a voice message to an individual or group of individuals based on the text in the uploaded spreadsheet. The voice message created comprises speech signals corresponding to text in the uploaded spreadsheet.

### BRIEF DESCRIPTION OF THE DRAWINGS

FIG. 1 shows a diagram for a VOIP based system for sending voice messages based on a web sites receipt of an email in accordance with an illustrative embodiment of the present invention.

FIG. 2 is a flow diagram illustrating the process of converting text in the body of an email to a voice message delivered to a recipient's telephone via the Internet in accordance with the operation of the illustrative embodiment of the system in FIG. 1.

FIG. 3 is a representation of the specific text format of the email incorporating an MTP security code, an individual or group name and a message to be received by a web site for conversion to a voice message.

FIG. 4 is a representation of the specific format of a spreadsheet incorporating a message in text for attaching to an email sent to a web site or uploading to a web site for conversion to a voice message in accordance of the illustrative embodiment of the system in FIG. 1.

### DETAILED DESCRIPTION OF PREFERRED EMBODIMENT

Illustrative System for Sending Voice Messages from Email Text via the Internet

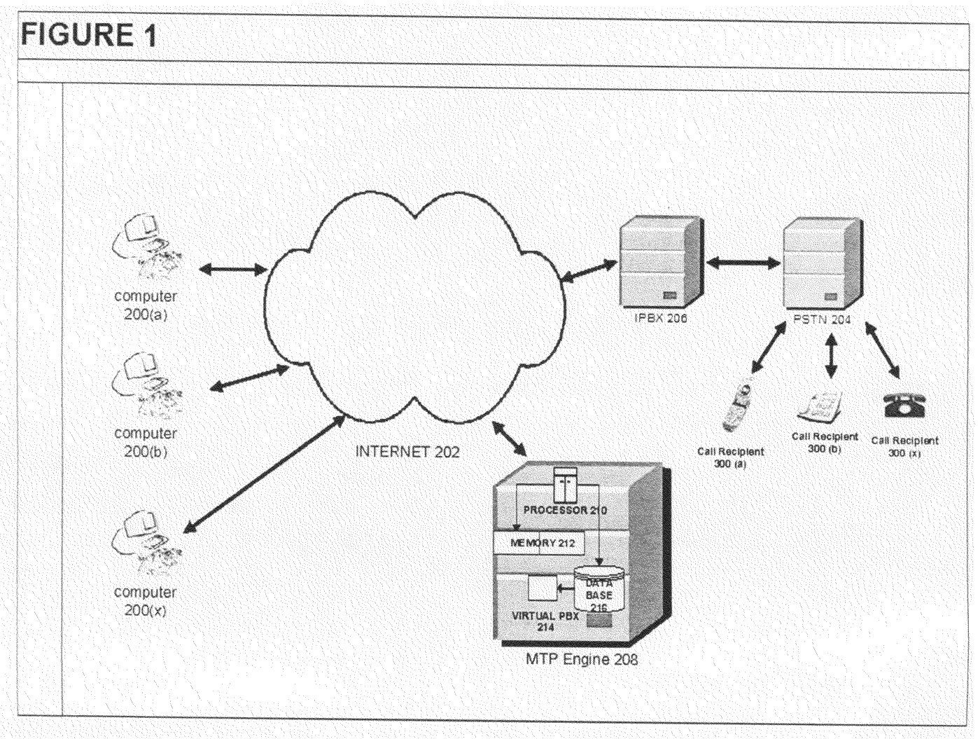

FIG. 1 shows a diagram of an illustrative embodiment of the present invention. The web site generates a voice message based on receipt of an email.

Individual computers 200(a), 200(b) . . . 200(x) are connected to the Internet 202 which is connected to the PSTN (Public Switched Telephone Network) 204 via an IPBX (Internet Private Branch Exchange) 206.

When an individual sends or receives an email via the Internet 202, a message is stored in the individual's mailbox on their source and destination server. When an email message arrives at the web site, the MTP engine 208 applies the appropriate security analysis to ensure that it recognizes the sender as a legitimate user of the service. If determined so, the MTP engine 208 then determines whether the sender maintains the appropriate amount of funds in their account. The MTP engine 208 then identifies which individual, or group of individuals should receive the message and then converts the text in the body of the email to a voice message and sends it along via the Internet 202 to an IPBX 206 for delivery to the PSTN 204 and ultimately to individual recipients 300(a), 300(b) . . . 300(x).

The MTP engine 208 is comprised of a processor 210, memory 212, virtual PBX 214 and a database 216. The processor 210 is a dedicated CPU (central processing unit). Memory 212 is comprised of conventional storage devices such as RAM (random access memory), ROM (read only memory) and a mass storage device such as a magnetic disc. Memory 212 is used to store the software operating routines for the processor 210. For example, software for checking security, checking account balances, converting a text message to a voice message and sending and receiving voice messages using VOIP signals over the Internet 202 to an IPBX 206 is stored in memory 212. A virtual PBX 214 provides a mechanism for connecting a database 216 to an IPBX 206. A database 216 provides a mechanism for storing an individual or group of individual's points of contact to which a voice message may be sent.

The database 216 is comprised of user account information, including the users MTP security code, their account balance, their individual or group of individual potential call recipients and their associated points of contract (e.g. telephone numbers and email addresses).

The Internet 202, the IPBX 206 and the PSTN 204 serve as the communications network coupling the text and voice messaging systems. Specifically, the MTP engine 208 which is comprised of a processor 210, memory 212, virtual PBX 214 and a database 216 is connected to the Internet 202 by software that is maintained in the MTP Engine 208. The block diagram of FIG. 1 further illustrates the connection of an MTP Engine 208 to the Internet 202.

Illustrative Operation of the System of FIG. 1.

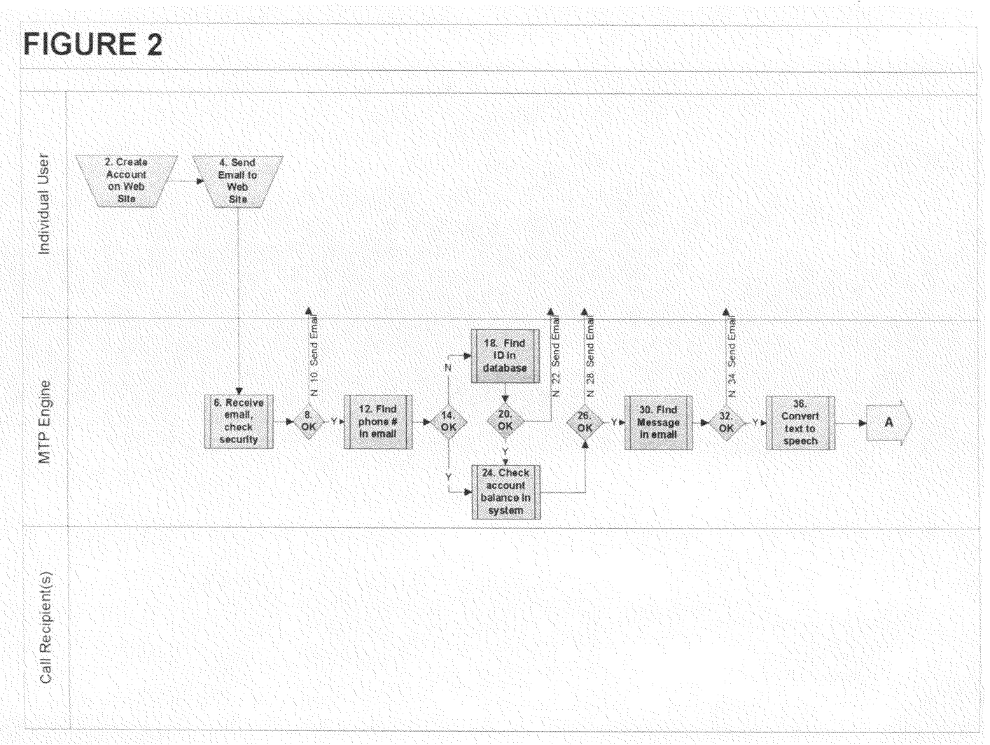

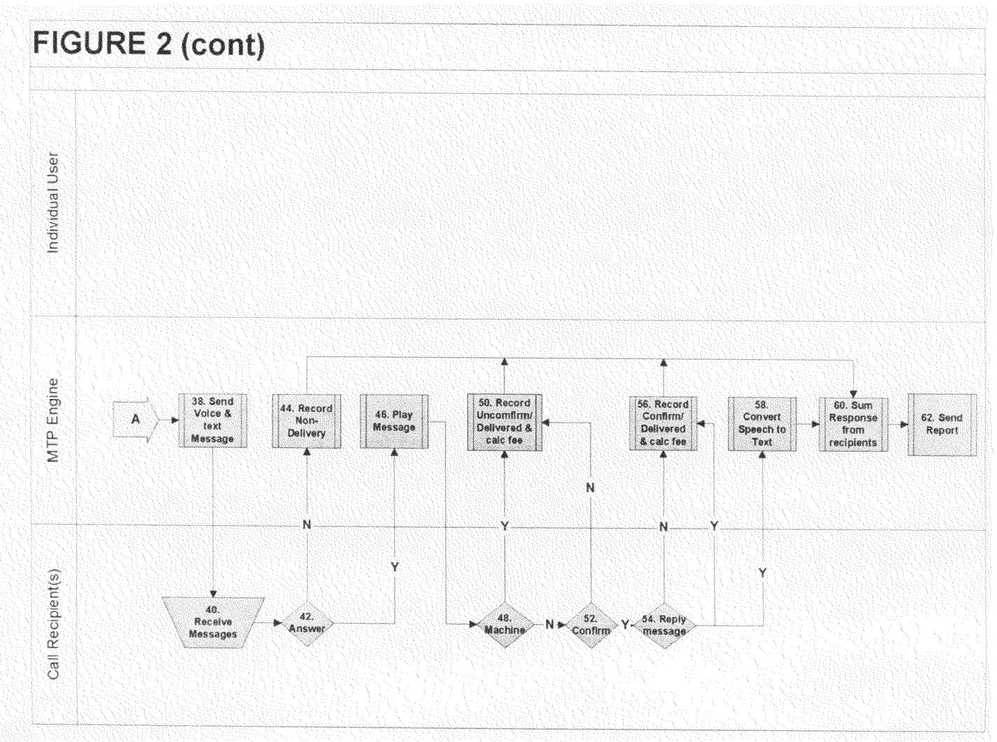

FIG. 2 is a flow diagram illustrating the process of converting text in the body of an email to a voice message delivered to a recipient(s) telephone via the Internet in accordance with the operation of the illustrative embodiment of the system in FIG. 1.

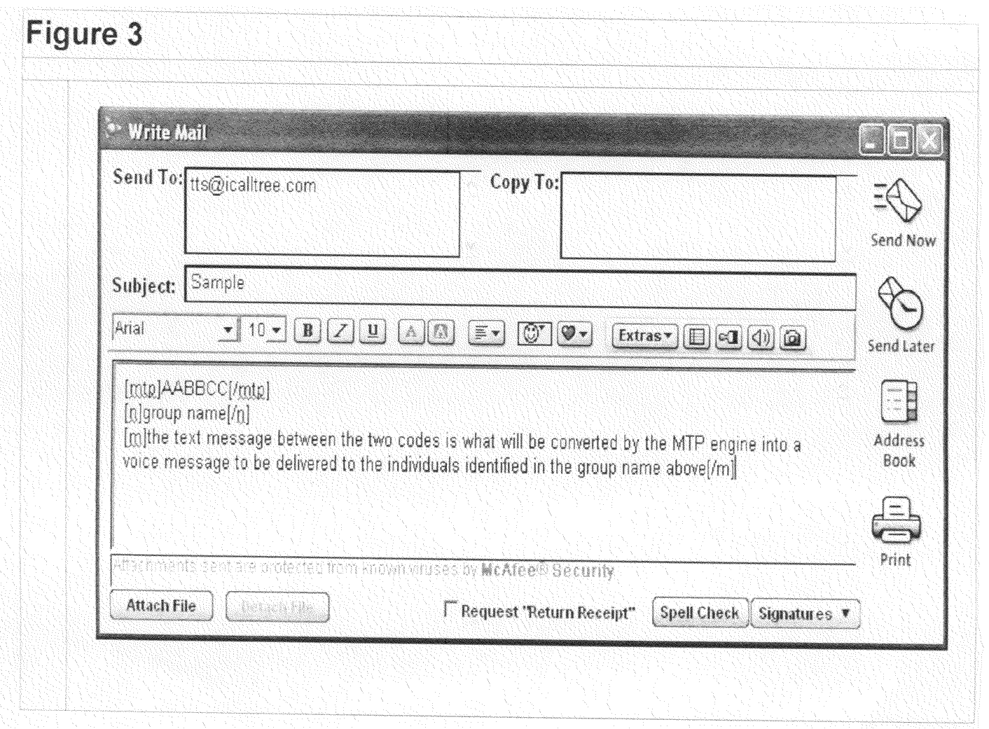

The illustrative procedure of FIG. 2 operates as follows. In step 2 an individual user creates an account at a web site. The user registers his/her email address, establishes a unique MTP security code, creates lists of individuals or groups of individuals, enters their associated points of contact (e.g. home phone, work phone, mobile phone, email address, etc) and adds funds to their account. The user then sends an email in a specific format to a mailbox on the web site in Step 4. The email contains the MTP security code, the individual or group name and the message text (See FIG. 3 below for an illustrative example of the required email format). In Step 6, the web site receives the email and the MTP Engine 208 checks the combination of email address and MTP security code to ensure that the email is being received from a valid system user. If the MTP Engine 208 identifies a valid user, Decision 8 proceeds to Step 12. If the MTP Engine 208 cannot identify a valid user, Decision 8 proceeds to Step 10 whereby the MTP Engine 208 sends an error email back to the user notifying them that they are not a valid user.

In Step 12, the MTP Engine 208 searches the email for the telephone number(s) to dial or the individual or group reference(s) to lookup in the database. If the MTP Engine 208 identifies telephone numbers, Decision 14 proceeds immediately to Step 24. If the MTP Engine 208 does not identify telephone numbers, Decision 14 proceeds to Step 18 whereby the MTP engine 208 attempts to identify individual or group references such as an email address or individual or group names within the body of the email. Step 18 conducts a lookup to Database 216 to determine the individual(s) or group(s) associated points of contact. If Decision 20 determines that a valid individual or group reference has been identified it proceeds to Step 24. If Decision 20 cannot determine a valid Database 216 value, it proceeds to Step 22 whereby the MTP Engine 208 sends an error email back to the user notifying them that they have not identified a valid individual or group reference.

In Step 24, the MTP Engine 208 then checks the amount of funds in the users account to ensue that the sender maintains sufficient funds to send messages. If the user maintains the appropriate amount of funds, Decision 26 proceeds to Step 30. If the user does not maintain the appropriate amount of funds, Decision 26 proceeds to Step 28 whereby the MTP Engine 208 sends an error email back to the user notifying them that they do not maintain enough funds in their account to make their desired calls.

In Step 30 the MTP Engine 208 identifies the text message to be sent. If the MTP Engine 208 successfully identifies the message, Decision 32 proceeds to Step 36. If the MTP Engine 208 does not identify the message, Decision 32 proceeds to Step 34 whereby the MTP Engine 208 sends an error email back to the user notifying them it was unable to find a message to deliver. In Step 36, the MTP Engine 208 uses conventional text-to-speech conversion procedures to create a voice message. In Step 38, the MTP Engine 208 simultaneously sends voice and text messages to all identified individuals points of contact in priority order. Voice Messages are delivered to the PSTN 204 via an IPBX 206.

In Step 40, the call recipients' telephones begin to ring. If the telephone rings without answer or the number is disconnected or no longer in service, Decision 42 proceeds to Step 44, whereby the MTP Engine 208 records the call status in Database 216 as Not Delivered. If the telephone call is answered, Decision 42 proceeds to Step 46. In Step 46, the MTP Engine 208 detects that the call has been answered and begins to play the message. If the telephone call is answered by the call recipients voice mail or answering machine, Decision 48 proceeds to Step 50 whereby the MTP Engine 208 detects that the call has been answered by an electronic recording device and continues playing the message into the recording device. Once the message is recorded, the MTP Engine 208 terminates the call, records the call status in Database 216 as unconfirmed/delivered and updates the call senders account balance by deducting the appropriate fee.

If the telephone call is not answered by a machine (e.g. a person), Decision 48, proceeds to Decision 52. In Decision 52 the MTP Engine 208 detects that the call has been answered by a person and continues playing the message to the person. Once the message is played, the MTP Engine 208 prompts the person to confirm receipt of the message by pressing a specific touchpad key. If the person terminates the call and does not confirm receipt, Decision 52 proceeds to Step 50 whereby the MTP Engine 208 interprets the lack of a confirmation signal sent by the call recipient by recording the call status in Database 216 as unconfirmed/delivered and updating the call senders account balance by deducting the appropriate fee. If the person confirms receipt of the call, Decision 52 proceeds to Decision 54 whereby the person is prompted to determine if they would like to record a reply message to be sent back to the sender. If the person chooses not to send a reply message, Decision 54 proceeds to Step 56 whereby the MTP Engine 208 terminates the call, records the call status in Database 216 as confirmed/delivered and updates the call senders account balance by deducting the appropriate fee. If the person does record a reply message, Decision 54 proceeds to both Step 56 and Step 58. In Step 56, the MTP Engine 208 terminates the call, records the call status in Database 216 as confirmed/delivered and updates the call senders account balance by deducting the appropriate fee. In Step 58, the MTP Engine 208 converts the recorded spoken message of the call recipient into text using conventional speech to text conversion technology.

In Step 60, the MTP Engine 208 summarizes the call status and reply messages from all call recipients into a report. In Step 62, the MTP Engine 208 sends a report via email to the call senders' computer summarizing the call status of each call recipient and the corresponding text message of each call recipient, if appropriate. Any recorded voice messages are attached to the email in .wav format.

FIG. 3 is an illustration of the specific format of the email required to be received in Step 4 of FIG. 2 above. When a website receives an email sent to a specific email address, the MTP Engine 208 attempts to distinguish the unique MTP security code in the body of the email by searching the body of the email and identifying the combination of contiguous numbers and letters which fall between bracketed tabs (e.g. [mtp] and [/mtp]) or specific text (e.g. mtpcode start and mtpcode end). After identifying the MTP security code and determining the validity of the user sending the email as detailed in Step 6 of FIG. 2 above, the MTP Engine 208 attempts to distinguish the message recipient telephone number(s) or individual or group reference(s) by searching the body of the email and identifying the text which falls between bracketed tabs (e.g. [n] and [/n]) or specific text (e.g. number start and number end). After identifying the message recipients and determining their points of contact as detailed in Step 12 in FIG. 2 above, the MTP Engine 208 attempts to distinguish the message to be delivered to the recipients by searching the body of the email and identifying text which falls between the bracketed tabs (e.g. [m] and [/m]) or specific text (e.g. message start and message end).

### Alternative Embodiments

In one alternative embodiment a web site receives an email with a spreadsheet attachment. The MTP engine 208 checks the MTP security code, user account balance, identifies telephone numbers or individuals or groups of individuals and messages and in turn generates a voice message based on the text in the spreadsheet attachment.

In another alternative embodiment a spreadsheet is uploaded directly to a web site. A user logs into a web site thereby appropriately identifying them as a legitimate user to the MTP Engine 208. The user then manually imports a spreadsheet consisting of the telephone numbers, email addresses, message recipient names, message subject and message. The MTP Engine 208 in turn then generates a voice message based on the text in the spreadsheet.

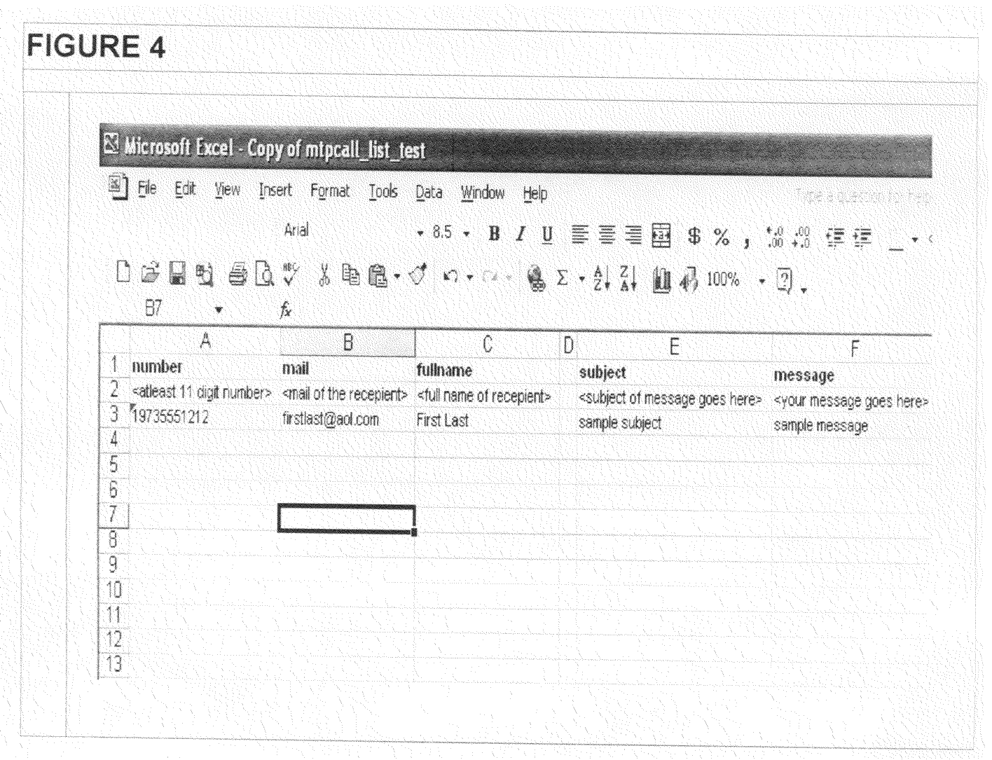

FIG. 4 is an illustration of the specific format of the spreadsheet to be attached to an email and sent, or uploaded directly to, a web site. The MTP Engine 208 processes the spreadsheet by searching the column headings for message recipient telephone number (see column heading labeled number), message recipient email address (see column heading labeled mail), message recipient first and last name (see column heading labeled full name), message subject (see column heading labeled subject) and message (see column heading labeled message). The spreadsheet attachment can contain as few as 1 record or as many as xx records and the message subject and message can change on a row by row basis.

Although a number of specific embodiments of the invention have been shown and described herein, it is to be understood that these embodiments are merely illustrative of the many possible arrangements which can be devised in application of the principles of the invention. Numerous and varied other arrangements can be devised in accordance with these principles by those of ordinary skill in the art without departing from the spirit and scope of the invention.

What is claimed is:

1. A method of sending voice messages to an individual or group of individuals based on an email received by a web site maintained on the Internet and connected to a communication network, the method comprising the steps of: the web site receiving the email; the MTP engine validating whether the sender of the email maintains the appropriate authorization to utilize the system; the MTP engine validating whether the sender of the email maintains the appropriate amount of funds in their web site account the; MTP engine determining the individual or group of individuals who should receive the message; the MTP engine generating a voice message responsive to the text message in the body of the email using conventional text-to-speech technology; the MTP engine sending signals to one or more individuals over the communications network to the PSTN at the same time; the MTP engine receiving digital data signals over the communications network from the PSTN; and the MTP engine sending an email to the sender of the original email which summarizes the signals received from the voice message recipients.

2. The method according to claim 1 wherein the communication network comprises the Internet connected to the PSTN via an IPBX and the signals comprised of bytes of data.

3. The method according to claim 1 wherein the web site receives text messages in the form of email.

4. The method according to claim 1 wherein the MTP engine validates that the sender of an email as a legitimate user of the system based the combination of the senders email address and a unique MTP security code, comprised of contiguous numbers and letters.

5. The method according to claim 1, wherein the MTP engine validates that the sender of an email maintains the appropriate amount of funds in the senders account.

6. The method according to claim 4 wherein the MTP engine identifies the unique MTP security code in the body of the email by the combination of contiguous numbers and letters which fall between a bracketed tab (e.g. [mtp]) at the beginning of the MTP security code and a bracketed tab (e.g. [/mtp] at the end.

7. The method according to claim 1 wherein the step of identifying the individual or group of individuals who should receive the voice message is determined by a message recipients telephone number, email address, user id or group association.

8. The method according to claim 7 wherein the MTP engine identifies the individual or group of individuals in the body of the email by the text which falls between a bracketed tab (e.g. [n]) at the beginning of the individuals telephone number, email address or user id or group association and a bracketed tab (e.g. [/n] at the end.

9. The method according to claim 1, wherein the MTP engine identifies the message in the body of the email by the text which falls between a bracketed tab (e.g. [m]) at the beginning of the message and a bracketed tab (e.g. [/m] at the end.

10. A method of sending voice messages to an individual or group of individuals based on an email with a text message maintained in a spreadsheet attachment received by a web site maintained on the Internet and connected to a communication network, the method comprising the steps of: the web site receiving the email with a spreadsheet attachment; the MTP engine validating whether the sender of the email maintains the appropriate authorization to utilize the system; the MTP engine validating whether the sender of the email maintains the appropriate amount of funds in their web site account; the MTP engine determining the individual or group of individuals who should receive the message; the MTP engine generating a voice message responsive to the text message in the body of the spreadsheet using conventional text-to-speech technology; the MTP engine sending signals to one or more individuals over the communications network to the PSTN at the same time; the MTP engine receiving digital data signals over the communications network from the PSTN; and the MTP engine sending an email to the sender of the original email with spreadsheet attachment which summarizes the signals received from the voice message recipients.

11. The method according to claim 10 wherein the communication network comprises the Internet connected to the PSTN via an IPBX and the signals comprised of bytes of data.

12. The method according to claim 10 wherein the web site receives text messages in the form of spreadsheet attachments to an email.

13. The method according to claim 10 wherein the MTP engine validates that the sender of an email with a spreadsheet attachment as a legitimate user of the system based the combination of the senders email address and a unique MTP security code, comprised of contiguous numbers and letters.

14. The method according to claim 10, wherein the MTP engine validates that the sender of an email with a spreadsheet attachment maintains the appropriate amount of funds in the senders account.

15. The method according to claim 13 wherein the MTP engine identifies the unique MTP security code in the body of the email with a spreadsheet attachment by the combination of contiguous numbers and letters which fall between a bracketed tab (e.g. [mtp]) at the beginning of the MTP security code and a bracketed tab (e.g. [/mtp] at the end.

16. The method according to claim 10 wherein the MTP engine identifies the telephone number of the individual or individuals who should receive the voice message by the column heading maintained in the spreadsheet attachment, namely Number.

17. The method according to claim 10 wherein the MTP engine identifies the individual or individuals who should receive the voice message by the column heading maintained in the spreadsheet attachment, namely Full name.

18. The method according to claim 10 wherein the MTP engine identifies the text message to be converted to a voice message by the column headings maintained in the spreadsheet attachment, namely Message Subject and Message.

19. A method of sending voice messages to an individual or group of individuals based on a text message maintained in a spreadsheet uploaded to a web site maintained on the Internet and connected to a communication network, the method comprising the steps of: a user logging into the web site; the MTP engine validating whether the user maintains the appropriate authorization to utilize the system; the user uploading a spreadsheet; the MTP engine validating whether the spreadsheet is in the appropriate format; the MTP engine validating whether the user maintains the appropriate amount of funds in their web site account to send messages; the MTP engine determining the individual or group of individuals who should receive the message; the MTP engine generating a voice message responsive to the text message in the body of the spreadsheet using conventional text-to-speech technology; the MTP engine sending signals to one or more individuals over the communications network to the PSTN at the same time; the MTP engine receiving digital data signals over the communications network from the PSTN; and the MTP engine sending an email to the user who uploaded the spreadsheet which summarizes the signals received from the voice message recipients.

20. The method according to claim 19 wherein the communication network comprises the Internet connected to the PSTN via an IPBX and the signals comprised of bytes of data.

21. The method according to claim 19 wherein the web site receives text messages in the form of spreadsheet uploads.

22. The method according to claim 19 wherein the MTP engine validates that the sender of an email with a spreadsheet attachment maintains the appropriate amount of funds in the senders account.

23. The method according to claim 19 wherein the MTP engine identifies the telephone number of the individual or individuals who should receive the voice message by the column heading maintained in the spreadsheet upload, namely Number.

24. The method according to claim 19 wherein the MTP engine identifies the individual or individuals who should receive the voice message by the column heading maintained in the spreadsheet upload, namely Full name.

25. The method according to claim 19 wherein the MTP engine identifies the text message to be converted to a voice message by the column headings maintained in the spreadsheet upload, namely Message Subject and Message.
